(19) United States
(12) Patent Application Publication
(10) Pub. No.: US 2018/0348939 A1
(43) Pub. Date: Dec. 6, 2018

(54) Method for Making a Computer Touchscreen with a more Rugged User Interface

(71) Applicants: Richard Bonar Davies, Sandy, UT (US); Christopher Allen Davies, Sandy, UT (US)

(72) Inventors: Richard Bonar Davies, Sandy, UT (US); Christopher Allen Davies, Sandy, UT (US)

(21) Appl. No.: 15/609,774

(22) Filed: May 31, 2017

(51) Int. Cl. G06F 3/041; G06F 3/01

(52) U.S. Cl. CPC G06F 3/0414; G06F 3/016

(57) ABSTRACT

Method for making a Standard Flat, Touchscreen Computer Monitor more rugged such that the ruggedized unit can be more effectively and better used in applications where effective use of the touchscreen interface by the user requires the user to gain tactile feedback from striking a 3 dimensional button in a forcible manner to activate the touchscreen with various parts of the hand (finger, front or back of hand, fist, gloved hand, other body part or an object, such as a ball or stick); without damage to the touchscreen device.

### BACKGROUND OF THE INVENTION

The present invention relates, in general, to visual-motor and neuro-cognitive evaluation and sport training devices for use in evidence based medical rehabilitation and sport performance evaluation, training and the methods of use of such devices and, more particularly, to a method to create such a useful and durable device by the modification of standard, commercially available flat touchscreen computer monitors so that such commercially available touch screen devices can be effectively used as rehabilitation and sport training devices, including the use of such a device in a hospital or clinic setting, user's home, sport facility, military or industrial environments. This invention also has applications to video games and other electronic devices that incorporate the use of a touchscreen user interface, where a more rugged user interface is needed or desired.

### BRIEF SUMMARY OF THE INVENTION

This invention teaches how to make and use a visual-motor and neuro-cognitive reaction measuring and training device that captures the manufacturing cost savings benefits of using a commercially available touchscreen computer monitor or a commercial non-touchscreen monitor to which has been added an after-market touchscreen face (such as Himalayastouchscreen.com) to give the standard monitor a touchscreen feature; without losing the important and very desirable features of user tactile feedback and illuminated raised buttons that can be struck repeatedly with a hard force or with an object; without damage to the monitor.

There are a number of visual-motor and neuro-cognitive evaluation and training devices being used in medically directed rehabilitation programs for persons recovering from stroke, traumatic brain injury (TBI), sport concussion, neuro surgery and other conditions or events affecting visual-motor and/or neuro-cognitive performance. Such devices are also widely used by athletes, sport teams and athletic trainers in the visual-motor and neuro-cognitive evaluation and training of athletes.

By far, the most widely used device of this type is the Dynavision Visual-Motor Reaction Device; manufactured and distributed by Dynavision International, LLC, in West Chester, Ohio. The Dynavision model 2000™ was first introduced into use in about 1990 and the follow-on model, the Dynavision D2™ replaced the 2000™ in 2010. There are more than 1,600 Dynavision devices in use throughout the U.S. and more than 20 foreign countries.

The Dynavision device is comprised of a large 4′×4′ board with a plurality of lighted mechanical buttons mounted on the face of the Board. The large face size of the board and the raised buttons are critical to its function—to challenge the entire visual field of the user and provide tactile feedback as he/she stands (or sits) in front of the device and presses (or hits) the raised switches as they randomly light-up. When an illuminated button is pressed, that light turns off and another random light turns on. The device keep score of how fast and accurately the user can respond to the lights.

In addition to the plurality of lights (64 lights) on the face of the Dynavision™ board, there is a screen located in the general center of the board. Changing letters, words, numbers, shapes, etc. can be programmed to display on this central screen; and the user is instructed to react to this information (i.e., call out information on the screen), while continuing to hit/press the lights as they illuminate. This is done to provide a neuro-cognitive challenge to the user.

There are other ‘large faced’ visual motor reaction devices that are somewhat similar to the Dynavision device, such as the Vision Coach™ Trainer (Perceptual Testing, Inc., California) and the BITS™ therapy system (Bioness, Inc., California). While both of these devices do have a large face area populated with individual points or dots of light that challenge a wide visual field, similar to the Dynavision device, the Vision Coach® achieves the lighted targets by randomly illuminating the face of the board behind membrane switches that do not substantially protrude from the face of the device; as do the illuminated mechanical push button switches used in the Dynavision. Further, the Vision Coach™ does not have an information screen on the face of the board.

Both the Dynavision™ and Vision Coach™ Devices are purpose designed and built for their intended use, such that, once designed, the entire board and electronics of each device must be separately fabricated, including installing multiple wires to each of the many illuminated buttons on the board.

By comparison, the Bioness BITS™ device is created using a commercially available large, flat screen, touch activated computer monitor. The BITS™ system computer is programmed to create light ‘spots’ on the screen that the user is instructed to ‘touch’ to turn off the light, as another lighted ‘spot’ turns on.

An important manufacturing and cost related advantage of this BITS™ device is that the individual mechanical lighted switches of the Dynavision™ and Vision Coach™ and related wiring are eliminated and replaced by simply programming illuminated dots/circles of light to appear on the touchscreen, and also programmed to turn-off when touched. Further, an area of the BITS™ monitor screen may be programmed to display information (numbers, letters, words, etc.) in the central area board, as per the Dynavision™.

While the BITS™ device and its use of a commercially available touchscreen activated computer monitor eliminates the need for a significant number of parts and related manufacturing costs, the BITS System when related to the Dynavision™ & Vision Coach™ and others; the BITS™ device, with its flat screen design, totally loses the important benefits to the user of raised lighted, 3 dimensional targets and tactical feed-back when the user touches the lighted dot. Raised, lighted targets are of particular importance in evaluating and training a user's peripheral vision.

In addition, and of great consequence, the user must touch or press the glass touchscreen with care. A hard strike to the screen with a fist, heal of the hand or knuckle can damage the monitor; and such strikes are common occurrences when the Dynavision™ is used by athletes, as they strive to achieve faster reaction times and higher scores. Further, many common touchscreen monitors will not respond to a touch by an object, e.g., a ball being held by a user of the BITS™ device; as these common touchscreens require contact with a part of the user's body, to cause a change in the electrical capacitance being sensed by the screen.

For the above reasons, the touchscreen computer monitor based devices are not well suited for use by many athletes that hit the board very hard and with a hand or objects or by persons recovering from stroke or brain injury that have lost manual dexterity to touch a lighted spot on the screen with a single finger, or in industrial and military applications where the user must respond to a situation by quickly and confidently striking a button to positively execute a critical command, such as; STOP or FIRE.

### DETAILED DESCRIPTION OF THE INVENTION

This invention is comprised of a (1) CASE into which a commercially available touchscreen computer monitor can be placed and secured; a mechanical (2) BUTTON or plurality of BUTTONS that can be secured to the CASE and a computer based (3) LEARN PROGRAM algorithm that can be caused to memorizes the location on the touchscreen where the touchscreen is touched, such that the touchscreen has the ability to re-illuminate in the same location(s) as the initial location of touch.

The CASE is made of strong, light weight, rugged, rigid materials, such as aluminum, plastic, steel; with a Front Side, Back Side, Right and Left Side and Top and Bottom Side, see FIGS. #1 & 2. The CASE is sized to the dimensions of a commercially available touchscreen computer monitor of choice; such that the inside dimensions of the CASE are larger than the outer dimensions of the computer monitor; allowing the monitor to be placed into the CASE and firmly secured within the CASE with the touchscreen face of the monitor facing the inside Front Side of the CASE, see FIG. #2. Further, a viewable window is created in a central area of the Front Side of the CASE, such that information displayed on that portion of the touchscreen is readily visible to the user of the device.

The BUTTON or BUTTONS are located on and secured to the Front Side of the CASE, see FIG. #1. The BUTTON is a mechanical assembly comprised of an Outer Portion (FIG. 3; 104) that is contacted by the person using the device and Inter Portion that contacts the face of the touchscreen, such that the movement and force conveyed to the inner portion by pressure on and movement of the outer portion of the BUTTON by the user is limited by the design of the BUTTON. This can be accomplished by having the Outer Portion of the BUTTON slide over the Inner Portion of the BUTTON (FIG. 3; 109) when the BUTTON is depressed, as in a telescope fashion.

The spring between the FACE of the CASE and the Outer Portion of the button (FIG. 3; 111) affects the force required to depress the BUTTON and the spring between the Outer Portion of the BUTTON and the Inner Portion of the BUTTON (FIG. 3; 110) affects and controls the force with which the Inner Portion of the BUTTON presses upon the face of the touchscreen. Thus, the force with which the Inner Portion of the BUTTON presses upon the face of the touchscreen is always within the safe range for such forces, without regard to the amount of force applied to the Outer Portion of the BUTTON, including the force necessary to compress the BUTTON. Thus, such force applied to the outer portion of the BUTTONS is borne by the FACE of the CASE and not the face of the Touchscreen.

The BUTTON is made of transparent or light transmitting material or hollow tube, such as clear acrylic plastic and positioned such that the light from an illuminated area of the touchscreen that is aligned in the CASE with the location of the BUTTON causes the BUTTON to be illuminated. The BUTTON also may be electrically conductive, such that the body capacitance of the user's body triggers the touchscreen when the BUTTON is depressed and touches the screen.

As needed; plastic parts of the BUTTON can be treated with commercially available clear conductive coatings to achieve the above described function. Light transmission through the BUTTON may also be achieved by having a hole or holes running the length of the BUTTON assembly.
Note: To insure that striking the BUTTON with an object (ball) triggers the touchscreen, the conductive BUTTONS can be electrically connected to the CASE and in turn to a common very low voltage source (e.g., 9 Volt battery) to provide an assured change in capacitance when anyone of the conductive BUTTONs touches the screen.

The BUTTON may also include a simple optical lens at the termination of the Inner Portion of the BUTTON (FIG. 3; 112). This lens will collect and focus the light from the illuminated area of the touchscreen onto the BUTTON assembly, to increase the brightness of the BUTTON when viewed by a user. In addition, an area of the Face of the Case surrounding a BUTTON may be of ridged translucent material, allowing light from the illuminated area of the touch screen monitor to be visible to the user, further designating the specific BUTTON to be addressed/pressed by the user.

The LEARN PROGRAM is a software algorithm that causes a lighted area/dot of light on the touchscreen to be positioned where a BUTTON makes contact with the touchscreen and to memorize that position on the touchscreen. Thus, the LEARN PROGRAM allows the controlling computer to know exactly where to create the illuminated areas on the touchscreen, such that the illuminated areas on the touchscreen are directly aligned with the location of the BUTTON(S) that are attached to the Front Side of the CASE. This direct method of learned alignment eliminates the need to measure, map out and transfer the BUTTON locations on the Front Side of the CASE to the face of the touchscreen. This also facilitates the interchange use of touchscreen monitors that are of a different size or length/width aspect ratio. While this LEARN PROGRAM is a desirable feature, the useful operation of this invention is not dependent upon this feature, as the proper and correct location of the BUTTON(s) in the face of the CASE may be simply accomplished by copying the programmed location of the illuminated areas of the touchscreen onto the face of the CASE and therein placing the BUTTONS.

### OPERATION OF THE INVENTION

A. The commercially available touchscreen computer monitor is secured within a CASE of the appropriate size that has a BUTTON or BUTTONS attached to the Front Side of the CASE.

B. The LEARN PROGRAM is activated and each BUTTON on the Front Side of the CASE is pressed to teach the controlling computer the relative location of each BUTTON that is on the Front Side of the CASE.

C. The controlling computer is placed in its normal user/run mode and a random area of the touchscreen illuminates behind one of the BUTTONS, illuminating that BUTTON.

D. The user is presented with an illuminated, raised, 3 dimensional mechanical button and he/she strikes the Outer Portion of the BUTTON, receiving tactile feedback.

E. The force of the impacted on the BUTTON is delivered to the Front Side of the CASE (not to the face of the touchscreen monitor) and the Inner Portion of the BUTTON touches the touchscreen of the monitor with a safe and appropriate force, as a result of the design of the BUTTON, as previously described.

F. The computer controlling the device senses the touch on the screen described in ‘E’ above and turns off the illuminated area behind that BUTTON and immediately illuminates an area behind another randomly selected BUTTON.

Steps D, E & F (above) continue until the program times out; in this case, with the operating computer recording the reaction time to hit each illuminated BUTTON.

Further Operation:

Available touchscreen monitors are rectangular in shape; wider than high. However, the preferred shape for visual-motor and neuro-cognitive reaction measuring and training devices is generally square (for example 4′×4′), such that the entire peripheral visual field is addressed. To allow rectangular touchscreen monitors to better fill this need, the disclosed invention includes the ability of the screen to be rotated on its stand or the wall at least 45 degrees, such that in the vertical or near vertical mode the upper and lower fields of vision of the user are fully challenged and in the horizontal position the full right to left visual field of the user is fully challenged. This feature includes a simple sensor that conveys to the software the position of the screen at the time of use of the device, causing the program to automatically adjust operation of the device to reflect the actual/real position of the screen (vertical or horizontal, etc.). This important feature allows a standard 48″ wide monitor to be effectively used to evaluate and to train the user's full field of vision, simply by repositioning the screen and without the user needing to interact with the programming of the device to reflect the change in orientation of the screen. The program also displays numbers, letters, shapes, colors, etc. on to the touchscreen in the area of located within the viewing opening present in the FACE of the CASE.

A Method for Achieving a ‘Button’ with Described Features

In addition to the BUTTON described above and illustrated in FIG. 3, there are alternate methods and designs for achieving the unique function of the BUTTON wherein the same force that the user exerts on the Outer Portion of the BUTTON does not transfer to the inner Portion of the BUTTON that contacts the touchscreen of the monitor; but rather, the Inner Portion of the BUTTON exerts a lesser force on the touchscreen than the force that the user exerts on the Outer Portion of the BUTTON and such force applied by the user to the Outer Portion of the BUTTON is born by the Front Side of the CASE.

One such method of achieving the above is to construct the BUTTON with an Outer Portion that is of ridged conductive, light transmitting material and an attached Inner Portion that is constricted of a flexible, conductive, compressible material, such as foam plastic, foam rubber, silicone or a coil spring.

In this construction, the travel of the BUTTON when depressed is a function of the combined length of the outer and Inner Portions of the BUTTON. Thus, if the distance from the Front Side of the CASE to the surface of the touchscreen is 1″, the forward travel of the entire BUTTON would need to be >1″, including the length of the compressible (or flexible) Inner Portion of the BUTTON. This configurations assures that the flexible or compressible distal end of the Inner Portion of the BUTTON will contact the touchscreen when the Outer Portion of the BUTTON is fully depressed, while limiting the force applied to the touchscreen.

In another construction, the Inner Portion of the BUTTON, including a flexible or compressible distal end, can be installed between the Front Side of the CASE such that this Inner Portion is in continuous contact with the touchscreen and protrudes through the Front Side of the CASE; and the Outer Portion of the BUTTON is depressed by the user, causing it to come in contact with the protruding Inner Portion, thus pressing on the face of the screen or by changing the electrical capacitance of the touchscreen and creating an input event to the controlling computer.

### DESCRIPTIONS OF DRAWINGS

FIG. 1/3 is a front view of the Case, showing the Face (101), Top Side (102) and Right Side of the case (103); the Outer Portion of the Button (104); and the location of the Computer Monitor Screen within the Case (105).

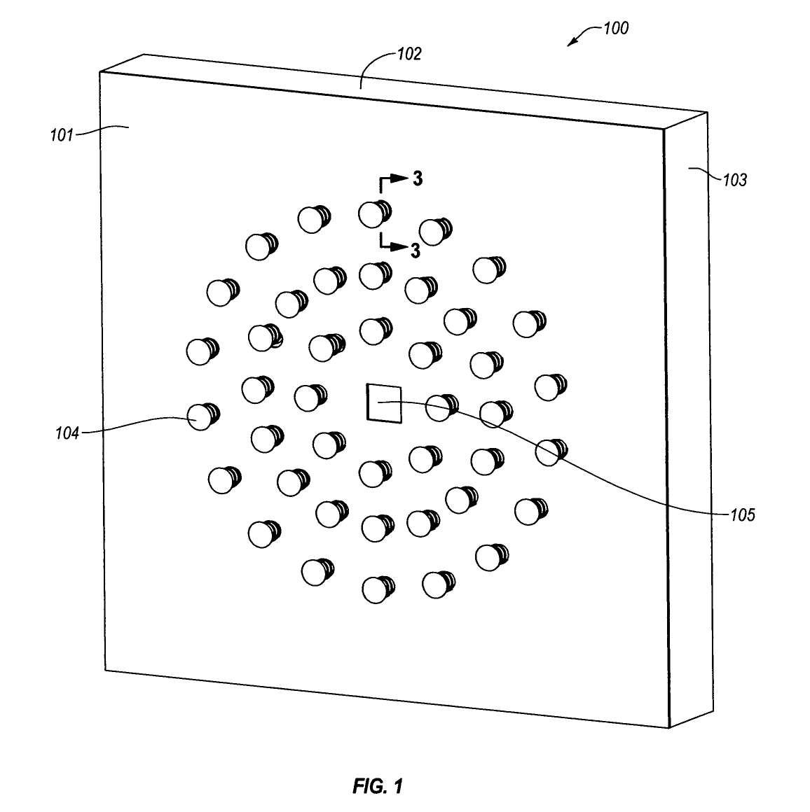

FIG. 2/3 shows an ‘exploded’ rear view of the subject device; with (106) being the back of the Case; (107) the Inner Portion of the Button; and (108) the location of the Touchscreen Computer Monitor.

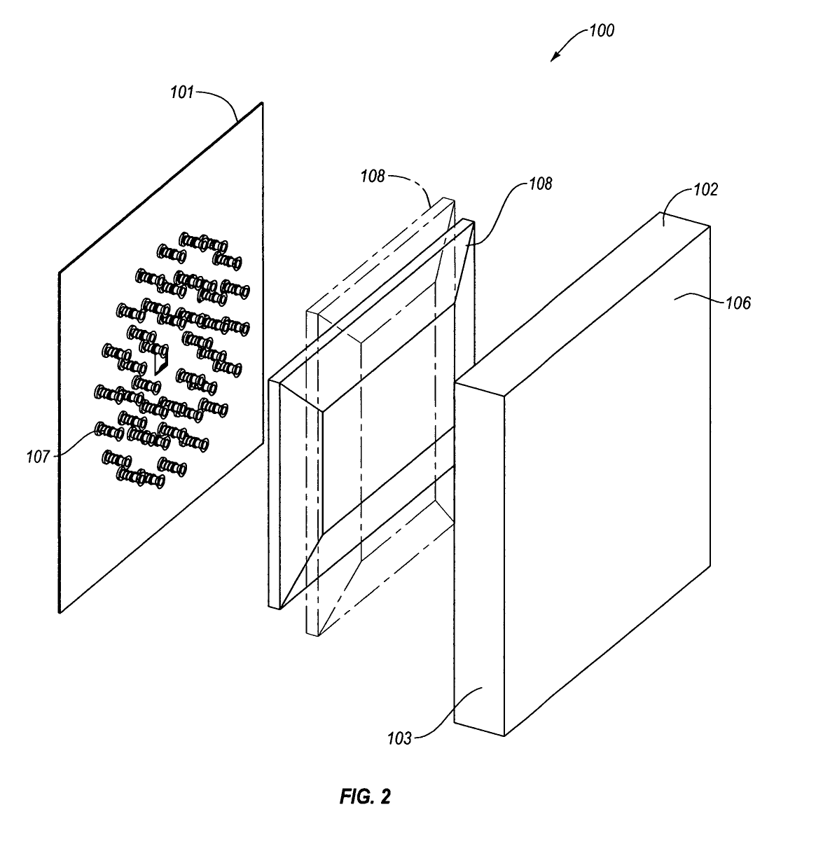

FIG. 3/3 shows a cross section of the BUTTON assembly; (109) the Inner Portion; (110) the spring on the Inner Portion of the Button; (111) the spring on the Outer Portion of the Button; (112) Light Collecting Lens; (113) Spring Retainer Ring.

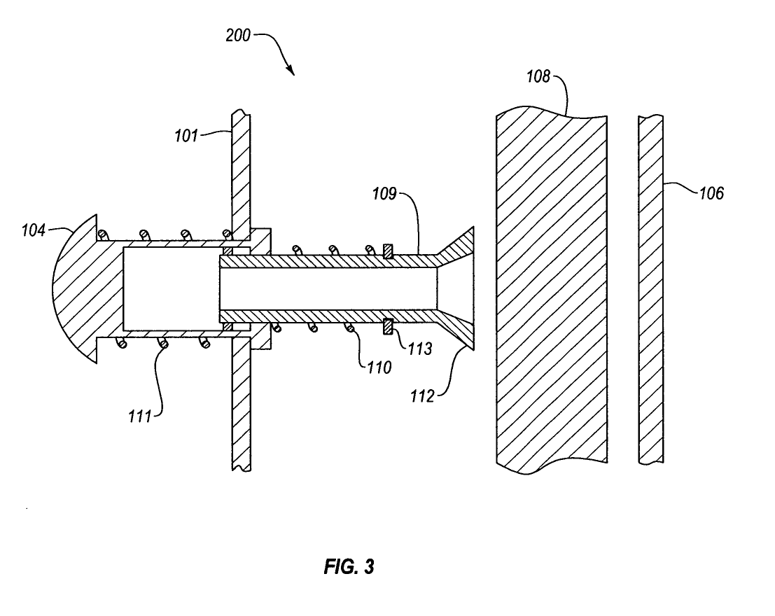

What is claimed:

1. A method for activating a touchscreen computer monitor, as previously herein described in detail, with the use of an intermediate mechanical device that is activated by being physically contacted by the user and such device is located between the user and the face of the touchscreen where such device is not secured to or supported by the user or the face of the said touchscreen and where such device is comprised of at least 2 sections that can be caused to compressed relative to one another along their linier axis when the end closest to the user (Outer Portion) is pressed by the user and the opposite end of said device (Inner Portion) is caused, by such pressing action, to contact the face of the touchscreen.

2. The device of claim 1 where the said intermediate mechanical device is supported by a rigid plate that is parallel to the face of the touchscreen and where such rigid plate is not supported by the face of the touchscreen computer monitor.

3. The intermediate mechanical device of claim 1 that is constructed with a compressible and resilient spring or compressible and resilient material that is located between the user's side of the mechanical device (outer portion) and the rigid plate of claim 2, and same said device with a compressible and resilient spring or compressible and resilient material between the first and second sections of the said mechanical device (inner portion), such that the force required to compress the inner portion of the device when it comes in contact with the screen is equal to or less than the force applied by the user to compress the outer portion of the device to cause it to come in contact with the rigid plate of claim 2.

4. The intermediate mechanical device of claim 3 where a compressible and resilient spring or compressible and resilient material is located between the most inner portion of the said mechanical device and the face of the touchscreen, such that the force required to compress the inner portion of the device to cause it to come in contact with the screen is equal to or less than the force applied by the user to compress the outer portion of the device to cause it to come in contact with the rigid plate of claim 2.

5. A method, as previously described, for improving the usefulness of a rectangular shaped computer monitor screen when used as a part of a device to evaluate and train the visual motor performance of the users by providing a mounting fixture for said screen that allows the user to rotate the screen at least 45 degrees, thereby placing the screen into a horizontal, vertical or near vertical position; and including a positioning sensor that senses the position of the screen and in so doing transmits the screen's position to the software program that is programmed to operate the visual motor device.
